(19) United States
(12) Patent Application Publication
(10) Pub. No.: US 2023/0298549 A1
(43) Pub. Date: Sep. 21, 2023

(54) MANIPULATOR FOR ELECTRONIC MUSICAL INSTRUMENTS

(71) Applicant: CASIO COMPUTER CO., LTD., Tokyo (JP)

(72) Inventor: Otoya Sakai, Tokyo (JP)

(73) Assignee: CASIO COMPUTER CO., LTD., Tokyo (JP)

(21) Appl. No.: 18/183,396

(22) Filed: Mar. 14, 2023

(30) Foreign Application Priority Data
Mar. 15, 2022 (JP) 2022-039927

(51) Int. Cl. G10H 1/34; F21V 8/00; G10H 1/00; G10H 1/14

(52) U.S. Cl. CPC G10H 1/34; G02B 6/0088; G02B 6/0066; G10H 1/0008; G10H 1/14; G10H 2210/325; G10H 2220/026; G10H 2220/265

(57) ABSTRACT

A manipulator includes a light source that emits light; a rotatable member that is rotatable around an axis; and an operation member having a substantially disk shape, attached to the rotatable member so as to be rotatable together with the rotatable member, the operation member including a light guide member that guides light incident from the light source, and a wheel member arranged on one plate surface side of the light guide member, wherein the rotatable member has a holding portion that holds the light guide member.

### BACKGROUND OF THE INVENTION

### Technical Field

The present invention relates to a manipulator for performance controls in electronic musical instruments and electronic musical instruments.

### Background Art

Conventionally, electronic musical instruments such as electronic pianos are known to have a manipulator for imparting performance effects such as pitch bend to musical tones. An electronic musical instrument of this type has been proposed to have a light-emitting portion and includes a light-guiding member that guides light emitted according to the operation manner of the operator, that is, according to the control manner of the performance effect.

For example, Japanese Patent Application Laid-Open No. 2018-54860 discloses an electronic keyboard instrument with a light-emitting portion that emits light according to the controlling of performance effects, and a rotatable pitch bender wheel unit (manipulator) for controlling performance effects. In this electronic keyboard instrument, the pitch bender wheel of the pitch bender wheel unit is fitted with a light guide plate that guides the light from the light emitting section, and rotates as the pitch bender wheel rotates.

### SUMMARY OF THE INVENTION

Features and advantages of the invention will be set forth in the descriptions that follow and in part will be apparent from the description, or may be learned by practice of the invention. The objectives and other advantages of the invention will be realized and attained by the structure particularly pointed out in the written description and claims thereof as well as the appended drawings.

To achieve these and other advantages and in accordance with the purpose of the present invention, as embodied and broadly described, in one aspect, the present disclosure provides a manipulator, comprising: a light source that emits light; a rotatable member that is rotatable around an axis; and an operation member having a substantially disk shape, attached to the rotatable member so as to be rotatable together with the rotatable member, the operation member including a light guide member that guides light incident from the light source, and a wheel member arranged on one plate surface side of the light guide member, wherein the rotatable member has a holding portion that holds the light guide member.

It is to be understood that both the foregoing general description and the following detailed description are exemplary and explanatory, and are intended to provide further explanation of the invention as claimed.

### BRIEF DESCRIPTION OF THE DRAWINGS

FIG. 1 is an overall perspective view of an electronic keyboard instrument according to an embodiment.

FIG. 2 is a perspective view of a left case of the electronic keyboard instrument according to the embodiment, viewed from the right side.

FIG. 3 is a perspective view of a pitch bender according to the embodiment as seen from the front right side.

FIG. 4 is a perspective view of the pitch bender according to the embodiment as seen from the front left side.

FIG. 5 is an exploded perspective view of the pitch bender according to the embodiment.

FIG. 6 is a side view of an operation wheel of the pitch bender according to the embodiment as seen from the right side, and is a side view showing the manner of rotation of the operation wheel.

FIG. 7A is a perspective view of a light guide member of the pitch bender according to the embodiment, and is a perspective view of the light guide member as seen from the front right side.

FIG. 7B is a perspective view of the light guide member of the pitch bender according to the embodiment, and is a perspective view of the light guide member as seen from the front left side.

FIG. 8 is a perspective view showing how the operation wheel is attached to the variable resistor attached to a fixing metal fitting in the pitch bender according to the embodiment.

FIG. 9 is a cross-sectional view of the pitch bender according to the embodiment, and is a cross-sectional view of the IX-IX cross section in FIG. 3.

### DETAILED DESCRIPTION OF EMBODIMENTS

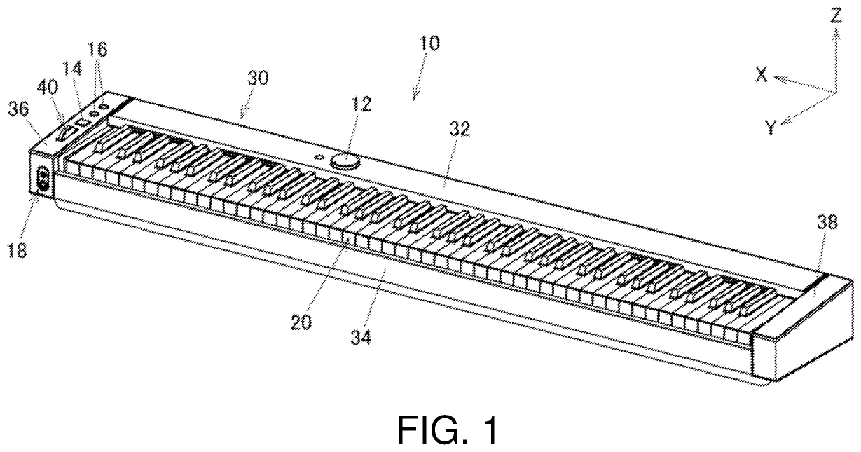

An embodiment of the present invention will be described with reference to the drawings. An electronic keyboard instrument (electronic musical instrument) 10 shown in FIG. 1 includes a keyboard 20 having a plurality of white keys and a plurality of black keys, and a case 30. A control board and the like are accommodated inside the case 30. Each figure shows coordinate axes; the X-axis direction in each figure is the left-right direction of the electronic keyboard instrument 10 (the positive direction of the X-axis is the left direction); the Y-axis direction in each figure is the front-rear direction of the keyboard instrument 10 (the positive direction of the Y-axis is defined as the front direction); and the Z-axis direction in each figure is the vertical direction of the electronic keyboard instrument 10 (the positive direction of the Z-axis is defined as the upward direction). The case 30 has a horizontally long rectangular shape with the left-right direction as the longitudinal direction, is made of synthetic resin, and is divided into an upper case 32, a lower case 34, a left case 36, and a right case 38. A part of the upper surface of the upper case 32 is provided with a dial 12 for controlling the volume of musical tones.

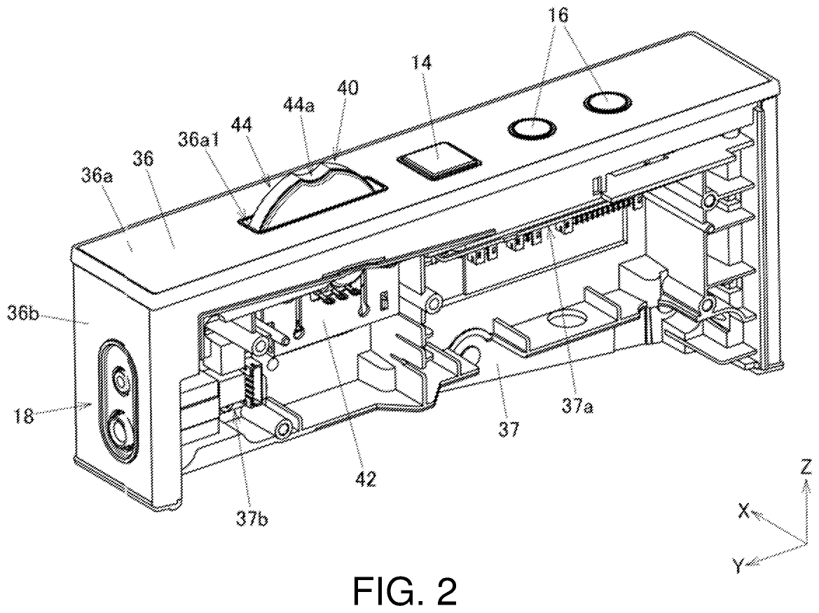

As shown in FIG. 2, the left case 36 has a top panel 36a forming its upper surface and a case side wall 36b forming its side wall. The front portion of the top panel 36a is provided with an operation opening 36a1 through which a portion of a pitch bender (manipulator) 40 (an operation wheel 44, which will be described later) is exposed for imparting pitch bend to musical tones and controlling the pitch bend.

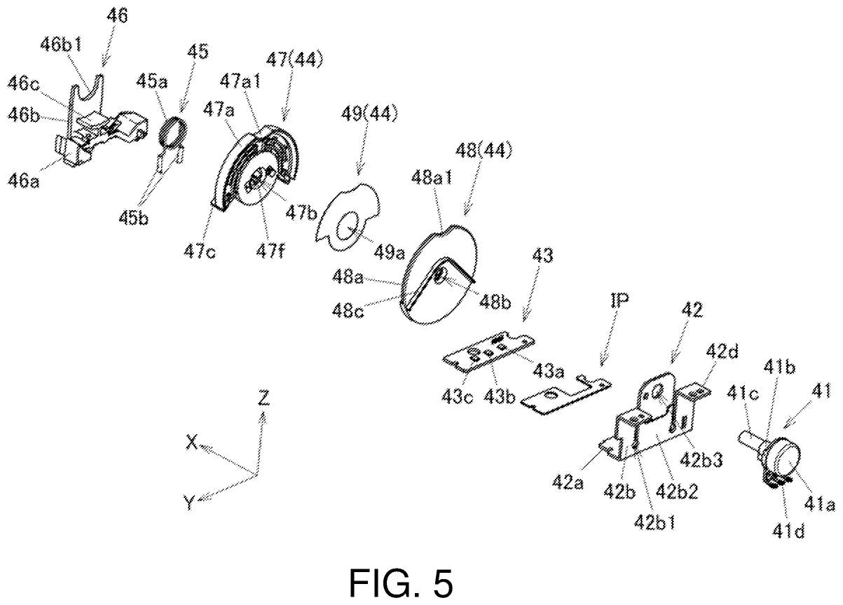

On the rear side of the top panel 36a, there are provided a light emission button 14 for starting or stopping the emission of each of the LEDs 43a to 43c (see FIG. 5, etc.) provided in the pitch bender 40, and setting buttons 16 for various settings. An earphone jack 18 is provided on the front surface of the case side wall 36b.

An internal frame 37 that is a frame-shaped member is provided on the inner surface side of the left case 36. Inside the internal frame 37, a first substrate 37a for accepting pressing operations of the light emission button 14 and the setting buttons 16, a second substrate 37b for accepting insertion/removal operations of the earphone jack 18, a pitch bender 40, and the like are attached. The first substrate 37a and the second substrate 37b and the first substrate 37a and the pitch bender 40 are electrically connected by connection wirings (not shown). Also, the first substrate 37a and the second substrate 37b are electrically connected to the control board of the electronic keyboard instrument 10 by connection wirings (not shown).

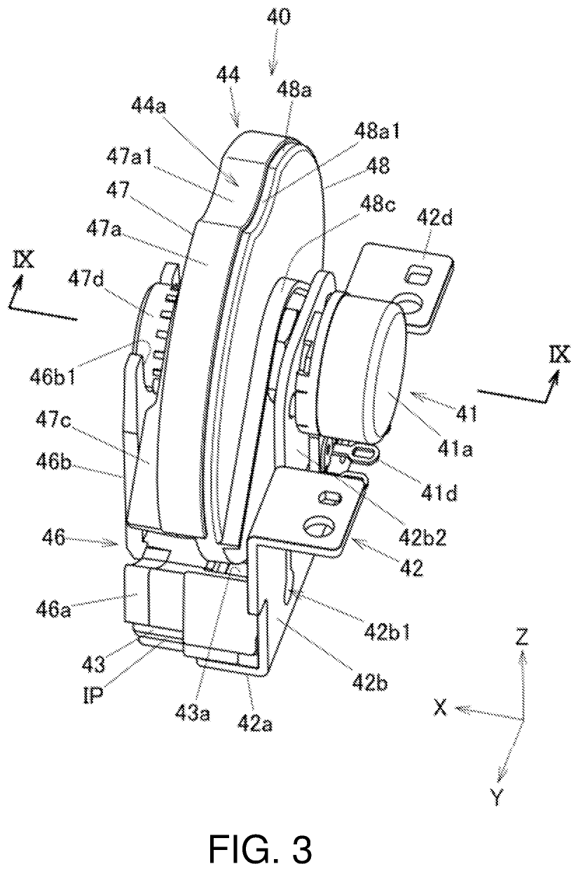

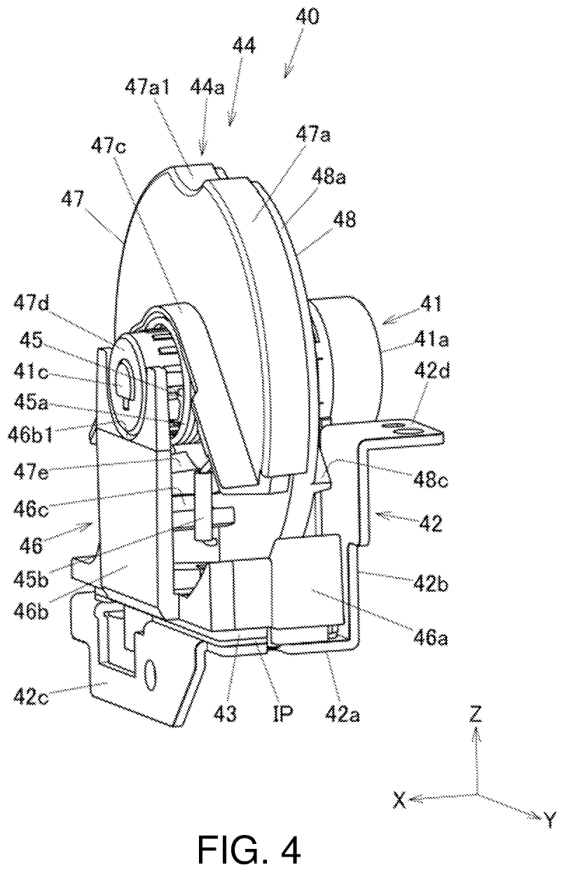

The configuration of the pitch bender 40 will be explained in detail. As shown in FIGS. 3 to 5, the pitch bender 40 includes a variable resistor (a part having a rotatable member) 41, a fixing metal fitting 42, a light source substrate 43, an operation wheel (operation member) 44, a torsion spring 45, and a holding member 46. The operation wheel 44 has a substantially disk shape, and has a wheel member 47, a light guide member 48, and a double-sided adhesive tape 49 for adhering the wheel member 47 and the light guide member 48 together (see FIG. 5). The upper portion of the operation wheel 44 is exposed through the operation opening 36a1 of the left case 36.

The variable resistor 41 is a rotatable rotary-type variable resistor, and includes a sensor front portion 41a, a sensor rear portion 41b, a shaft-shaped member (holding member) 41c, and three wiring connection parts 41d extending from the lower side of the sensor front portion 41a. The sensor front portion 41a has a substantially circular columnar shape, and the sensor rear portion 41b has a substantially cylindrical shape that is narrower than the sensor front portion 41a and protrudes leftward from the left side of the sensor front portion 41a. The sensor front portion 41a and the sensor rear portion 41b constitute a rotation angle sensor.

The shaft-shaped member 41c extends axially along the left-right direction, and the right end thereof is inserted into the cylindrical inner side of the sensor rear portion 41b so as to be rotatable around the axis. The shaft-shaped member 41c has a substantially half-moon cross section at a portion exposed from the sensor rear portion 41b except for the vicinity of the boundary portion with the sensor rear portion 41b. A connection wiring connected to the first substrate 37a is connected to each of the wiring connection parts 41d. The variable resistor 41 detects the rotation angle of the shaft-shaped member 41c from the resistance value that changes according to the rotation of the shaft-shaped member 41c with respect to the sensor front portion 41a and the sensor rear portion 41b, converts the rotation angle into an electric signal, and outputs the electrical signal to the first substrate 37a through the connection wirings.

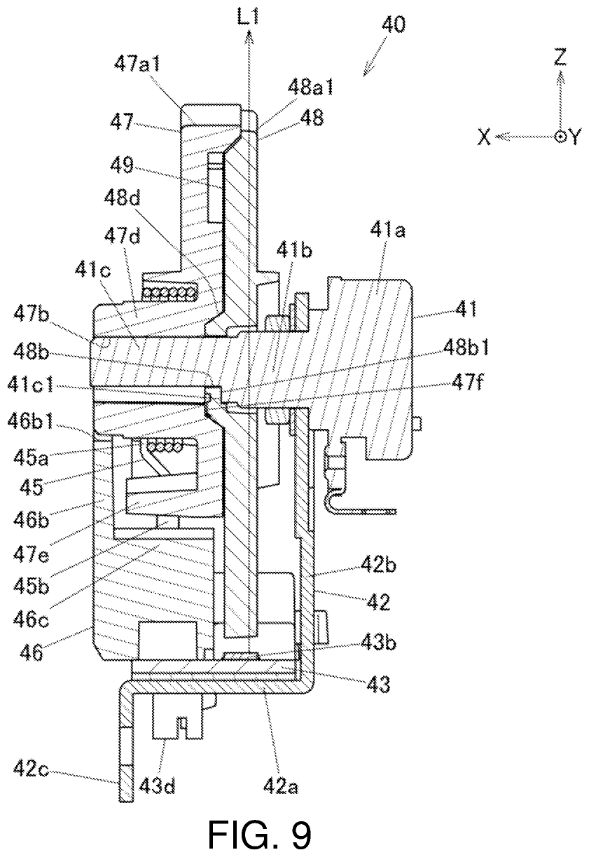

The fixing metal fitting 42 is a metal fitting for fixing respective members constituting the pitch bender 40 to each other and for fixing the pitch bender 40 to the inner frame 37, and has a substantially L-shaped cross section (see FIG. 9). The fixing metal fitting 42 includes a flat plate portion 42a arranged with its plate surfaces facing in the vertical directions, and a standing wall 42b rising from the right end of the flat plate portion 42a in a flat plate shape with its plate surfaces facing in the horizontal directions. The fixing metal fitting 42 includes a first screwing portion 42c extending downward from a part of the left end portion of the flat plate portion 42a, and second screwing portions 42d extending rightward from respective front and rear ends of the rising tip portion of the standing wall portion 42b. The fixing metal fitting 42 is fixed to the inner frame 37 by screwing the first screwing portion 42c and the second screwing portions 42d to the inner frame 37, respectively.

A pair of slits 42b1 that are open upward and extend in the vertical direction are provided at respective inner sides of the vertical wall portion 42b from which the two second screwing portions 42d extend. At the inner sides relative to the two slits 42b1, a plate-shaped resistor fixing portion 42b2 is provided, extending upward from the height position of the two second screwing portions 42d. In the resistor fixing portion 42b2, a circular opening 42b3, through which the sensor rear portion 41b of the variable resistor 41 is inserted, is formed in a portion positioned above the two second screwing portions 42d. The variable resistor 41 is coupled to the resistor fixing portion 42b2 by bolting with the sensor rear portion 41b inserted into the fixing opening 42b3. With the slits 42b1 provided on both sides of the resistor fixing portion 42b2, the resistor fixing portion 42b2 is more flexible than other parts of the fixing metal fitting 42 in a horizontal direction (i.e., the direction of the axis of the shaft-shaped member 41c) in a state where the fixing metal fitting 42 is fixed to the inner frame 37.

The light source substrate 43 is a flat printed circuit board arranged with its flat surfaces facing up and down. The light source substrate 43 is placed on the flat plate portion 42a of the fixing metal fitting 42 and fixed to the flat plate portion 42a by screwing. The light source substrate 43 is provided thereon with three LEDs (light source units) 43a, 43b, and 43c that emit light of different wavelength bands. The LEDs 43a to 43c are linearly arranged at regular intervals along the front-rear direction, and emit light upward from the light source substrate 43. A substantially rectangular parallelepiped light source connector 43d is provided on the lower surface of the light source substrate 43 (see FIG. 9). A connection wiring extending from the first substrate 37a side is connected to the light source connector 43d. An insulating plate IP is sandwiched between the flat plate portion 42a of the fixing metal fitting 42 and the light source substrate 43 to insulate them from each other.

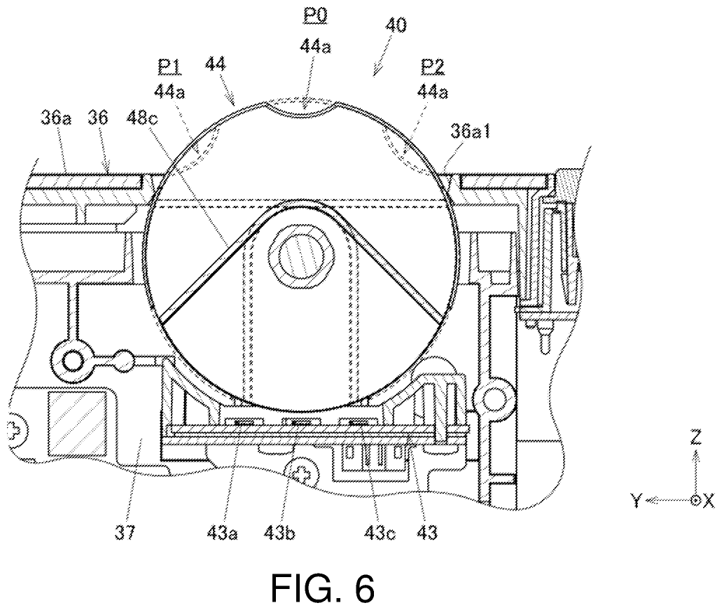

The operation wheel 44 is attached to the shaft-shaped member 41c of the variable resistor 41, and rotates together with the shaft-shaped member 41c around the axis of the shaft-shaped member 41c. A portion of the upper surface of the operation wheel 44 is provided with an operation recess 44a that is recessed in a substantially arc shape. The operation recess 44a is exposed from the operation opening 36a1 of the left case 36, and is provided so that the operator can easily rotate the operation wheel 44 by placing a finger or the like thereon. As shown in FIG. 6, the operation wheel 44 has an initial state P0 in which the operation recess 44a is directed vertically upward, and is rotatable between a first state P1 that is rotated from the initial state P0 towards the front side by 45 degrees around the axis of the shaft-shaped member 41c and a second state P2 that is rotated towards the rear side by 45 degrees.

The wheel member 47 of the operation wheel 44 is made of synthetic resin, and is a generally fan-shaped plate-like member in which about ¼ of a circle is missing at the lower portion. An outer wall portion 47a that slightly extends rightward in the form of a wall is provided on the edge of the wheel member 47 except for the lower portion (see FIG. 5). A wheel-side recessed portion 47a1, which is recessed in an arc shape and constitutes a part of the operation recess 44a, is provided in the central portion, in the front-rear direction, of the upper portion of the outer wall portion 47a. A wheel-side through hole (second through hole) 47b extending in the left-right direction is provided in the substantially central portion of the wheel member 47 in a substantially half-moon shape corresponding to the cross-sectional shape of the shaft-shaped member 41c. The wheel member 47 is fixed to the shaft-shaped member 41c by inserting the shaft-shaped member 41c into the wheel-side through hole 47b.

In addition, around the wheel-side through-hole 47b on the left plate surface of the wheel member 47, a wheel-side projecting portion 47c projecting leftward is provided. The wheel-side protruding portion 47c is provided in a substantially L shape when viewed from the left side so that the wheel-side through hole 47b is hidden when the wheel member 47 is viewed from above. A left plate surface of the wheel member 47 is provided with a spring fixing portion 47d projecting leftward in a substantially cylindrical shape (see FIG. 3). The wheel-side through hole 47b described above is provided so as to pass through the inside of the spring fixing portion 47d. Below the spring fixing portion 47d, a first spring abutting portion 47e is provided that protrudes leftward in a substantially flat plate shape with its plate surfaces facing generally vertically. The plate surface of the first spring contact portion 47e is gently curved so as to be convex downward.

The light guide member 48 of the operation wheel 44 has a substantially disc shape and is made of a material with excellent transmittance (for example, acrylic resin). As shown in FIG. 6, the light guide member 48 is arranged above the light source substrate 43 with slight gaps with the LEDs 43a to 43c so that light emitted from LEDs 43a to 43c enter from the lower portion of light guide member 48. The left plate surface of the light guide member 48 is attached to the plate surface located inside the outer wall portion 47a of the wheel member 47 via a double-sided adhesive tape 49, and rotates together with the wheel member 47 around the axis of the shaft-shaped member 41c. A tape-side through-hole 49a through which the shaft-shaped member 41c is inserted is provided in a substantially central portion of the double-sided tape 49. Thus, the wheel member 47 is arranged on a one side of the plate surface of the light guide member 48 and supports the light guide member 48.

In the end edge 48a of the light guide member 48, at the center of the upper portion in the front-rear direction, a light guide side recess 48a1 that is recessed in a substantially arc shape in substantially the same shape as the wheel side recess 47a1 and that constitutes a part of the operation recess 44a is provided. A light guide-side through hole (first through hole) 48b penetrating in the left-right direction is provided at substantially the center of the side surface of the light guide member 48. The light guide member 48 has the shaft-shaped member 41c inserted through the light guide-side through hole 48b, and rotates together with the wheel member 47 around the axis of the shaft-shaped member 41c. Around the light guide-side through hole 48b on the right plate surface of the light guide member 48, a light guide side projecting portion 48c projecting rightward is provided. The light guide side projecting portion 48c is provided in a substantially L shape when viewed from the right side so that the light guide-side through hole 48b is hidden when the light guide member 48 is viewed from above. As will be described later, part of the light guide member 48 is in contact with part of the variable resistor 41, so that the light guide member 48 is sandwiched between the wheel member 47 and the variable resistor 41.

The torsion spring 45 has a coil spring portion 45a and a pair of urging portions 45b. The coil spring portion 45a is a coil spring, and is fixed to the spring fixing portion 47d while being wound around the outer peripheral surface of the spring fixing portion 47d. Both ends of the coil spring portion 45a extend below the spring fixing portion 47d. The pair of urging portions 45b are made of elongated cylindrical rubber members inserting the respective ends of the coil spring portion 45a therein. When the operation wheel 44 is in the initial state P0, the pair of urging portions 45b urge the first spring contact portion 47e such that the inner portions sandwich the first spring contact portion 47e while contacting the first spring contact portion 47e.

The holding member 46 is made of synthetic resin and is a member for holding the position of the torsion spring 45. The holding member 46 has a bottom portion 46a and a side plate portion 46b. The bottom portion 46a is arranged above the light source substrate 43 and is shaped so as not to cover the light emitting sides of the LEDs 43a to 43c. Both front and rear sides of the bottom portion 46a are slightly raised in a block shape, and the inner surface thereof is recessed in a curved shape along the outer peripheral surface of the operation wheel 44. The side plate portion 46b rises in a flat plate shape from the left end portion of the bottom portion 46a to the spring fixing portion 47d of the wheel member 47 with its plate surfaces oriented in the horizontal directions. At the tip of the side plate portion 46b, a wheel receiving portion 46b1 is provided which is cut out in a substantially arc shape along the outer peripheral surface of the spring fixing portion 47d. The wheel receiving portion 46b1 is provided close to the spring fixing portion 47d with a small gap therebetween.

In addition, a portion of the right side plate surface of the side plate portion 46b located below the first spring contact portion 47e is provided with a second spring contact portion 46c that protrudes to the right in a substantially flat plate shape with its plate surfaces facing in the vertical directions. The plate surface of the second spring contact portion 46c is gently curved so as to be convex downward, and has substantially the same width as the first spring contact portion 47e. When the operation wheel 44 is in the initial state P0, the pair of urging portions 45b of the torsion spring 45 are in contact with the second spring contact portion 46c while the inner sides of the urging portions 45b sandwich the second spring contact portion 46c and urge the spring contact portion 46c at a position below the first spring contact portion 47e.

In the pitch bender 40 configured as described above, when the operation wheel 44 is rotated, the shaft-shaped member 41c of the variable resistor 41 interlocks with the operation wheel 44, and the shaft-shaped member 41c rotates around its axis. When the shaft-shaped member 41c rotates, the variable resistor 41 converts the rotation angle into an electric signal and outputs the electric signal to the first substrate 37a. The electrical signal output to the first substrate 37a side is output to a control board of the electronic keyboard instrument 10 via the first substrate 37a, and is analyzed and controlled by the control board so as to apply a pitch bend effect on musical tones of the electronic keyboard instrument 10 that corresponds to the rotation angle of the operation wheel 44.

Further, in the pitch bender 40, when the operation wheel 44 is rotated to the front side, the wheel-side protruding portion 47c sandwiches the biasing portion 45b, on the front side, of the torsion spring 45, and indirectly contacts the front side end of the second spring contact portion 47c so that the rotation of the operation wheel 44 to the front side is restricted in the first state P1 in which the operation wheel 44 is rotated 45 degrees to the front side from the initial state P0. Similarly, when the operation wheel 44 is rotated to the rear side, the wheel-side protruding portion 47c sandwiches the biasing portion 45b, on the rear side, of the torsion spring 45, and indirectly contacts the rear side end of the second spring contact portion 47c so that the rotation of the operation wheel 44 to the rear side is restricted in the second state P2 in which the operation wheel 44 is rotated 45 degrees to the rear side from the initial state P0. In addition, within the range in which the operation wheel 44 can be rotated, the light source substrate 43 and the like are not visible through the operation opening 36a1 due to the wheel-side projecting portion 47c and the light guide-side projecting portion 48c provided on the operation wheel 44.

Further, in the pitch bender 40, when the operation wheel 44 is rotated, one of the pair of urging portions 45b of the torsion spring 45 contacts the first spring contact portion 47e and is separated from the second spring contact portion 46c, and the other of the pair of urging portions 45b of the torsion spring 45 contacts the second spring contact portion 46c ad is separated from the first spring contact portion 47e, thereby widening the distance between the pair of urging portions 45b. Therefore, when the operation wheel 44 is rotated from the initial state P0 and a finger or the like is released from the operation recess 44a of the operation wheel 44, the elastic restoring force of the torsion spring 45 moves the operation wheel 44 to the initial state P0. That is, the position of the torsion spring 45 is held by the holding member 46 (second spring contact portion 46c).

Also, in the pitch bender 40, the light emission status of each of the LEDs 43a to 43c is controlled by the control board in accordance with the pitch bend effect imparted to the musical tone, other operation statuses, or the like. Specifically, the control board performs control to change the light emission color, light emission interval, and the like of each of the LEDs 43a to 43c. The light emitted from each of the LEDs 43a to 43c enters from the lower portion of the edge 48a of the light guide member 48, is diffused, and is guided in the light guide member 48 in its radial directions. The light guided in the light guide member 48 is emitted from the upper part of the edge 48a of the light guide member 48, and the player can visually recognize the light emitted outside the operation opening 36a1 (see optical path L1 shown in FIG. 9). This allows the player to know the musical tone control state of the electronic keyboard instrument 10.

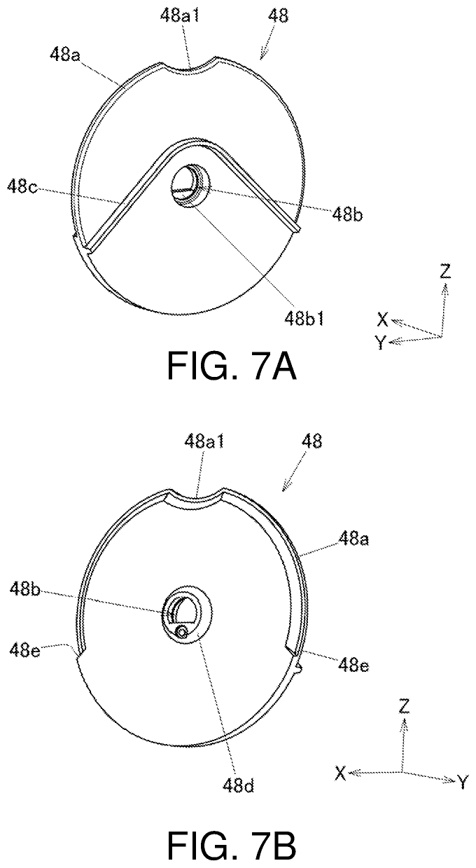

Next, the structure related to the contact portion between the light guide member 48 and the variable resistor 41 will be described in detail. As shown in FIG. 7B , a raised portion 48d that protrudes leftward in a substantially truncated cone shape is provided at substantially the center of the left plate surface of the light guide member 48. The light guide-side through hole 48b is provided so as to pass through the raised portion 48d. As shown in FIGS. 7A and 7B, of the opening of the light guide-side through hole 48b, the opening shape of the portion located at the raised portion 48d is substantially half-moon shape, and the opening shape of the other portion is circular. For this reason, a step is provided in the boundary portion between the portion located in the raised portion 48d and the other portion in the opening of the light guide-side through hole 48b, and the surface forming this step constitutes a light guide-side contact surface (second contact surface) 48b1 that comes into contact with a part of the variable resistor 41. The light guide-side contact surface 48b1 is orthogonal to the axial direction (horizontal direction) of the shaft-shaped member 41c.

A fitting recess 47f is provided in the substantially central portion of the wheel member 47 so that the raised portion 48d is fitted when the wheel member 47 and the light guide member 48 are coupled (see FIG. 5). The wheel-side through hole 47b is provided so as to pass through the fitting recess 47f. Further, the tape-side through hole 49a provided in the double-sided adhesive tape 49 is sized so that when the double-sided tape 49 is attached to the left plate surface of the light guide member 48, its opening edge surrounds the raised portion 48d. Therefore, when the wheel member 47 and the light guide member 48 are bonded together via the double-sided tape 49, the raised portion 48d of the light guide member 48 is fitted into the fitting recess 47f of the wheel member 47, and the outer surface of the raised portion 48d contacts the inner surface of the fitting recess 47f (see FIG. 9).

In addition, as shown in FIG. 7B, in a region of the edge 48a of the light guide member 48 on the left side near the center positions, whirl-stop portions 48e are provided so that they are in proximity to or in contact with the front and rear edges, respectively, of the outer wall portion 47a of the wheel member 47 when the wheel member 47 and the light guide member 48 are bonded to each other. For this reason, when the adhesive force between the wheel member 47 and the light guide member 48 weakens, even if a rotational force is applied to the light guide member 48 to rotate independently from the wheel member 47, the whirl-stop portions 48e interfere with the outer wall portion 47a to prevent the light guide member 48 from rotating independently of the wheel member 47.

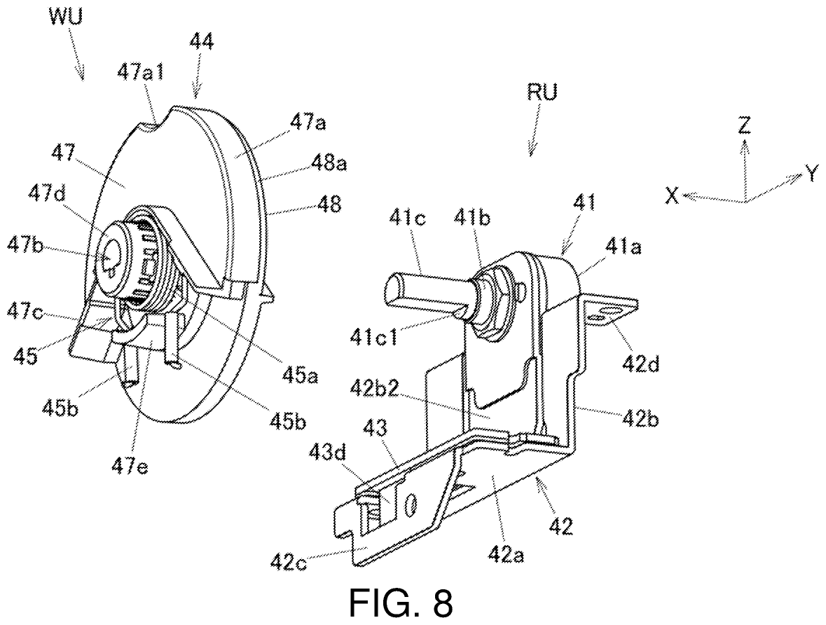

On the other hand, as shown in FIG. 8, the shaft-shaped member 41c of the variable resistor 41 has a circular cross-section near the boundary with the sensor rear portion 41b, and a substantially half-moon cross-section at other portions. For this reason, the shaft-shaped member 41c has a step at the boundary between the circular cross-sectional portion and the substantially half-moon cross-sectional portion, and the surface of the step is a resistor-side contact surface (first contact surface) 41c1 that contacts the light guide-side contact surface 48b1 of the light guide member 48. The surface of the resistor-side contact surface 41c1 is orthogonal to the axial direction (horizontal direction) of the shaft-shaped member 41c.

Next, the manner of assembling the variable resistor 41 and the operation wheel 44 will be described. As shown in FIG. 8, in the process of assembling the pitch bender 40, a unit in which the variable resistor 41, the fixing metal fitting 42, and the light source substrate 43 are assembled (hereinafter referred to as “resistor unit RU”), and a unit in which the wheel member 47, the light guide member 48, and the torsion spring 45 are assembled (hereinafter referred to as “wheel unit WU”) are assembled together, and then the holding member 46 is installed.

When assembling the resistor unit RU and the wheel unit WU, the resistor unit RU is positioned so that the resistor-side contact surface 41c1 of the variable resistor 41 contacts the light guide-side contact surface 48b1 of the light guide member 48. Then, the shaft-shaped member 41c of the variable resistor 41 is inserted into the light guide-side through hole 48b and the wheel-side through hole 47b until the resistor-side contact surface 41c1 contacts the light guide-side contact surface 48b1. At this time, the shaft-shaped member 41c is press-fitted into the wheel-side through hole 47b. Through the above procedure, the resistor unit RU and the wheel unit WU are assembled. Thereafter, the spring fixing portion 47d of the wheel member 47 is held by the wheel receiving portion 46b1 of the holding member 46, and the bottom portion 46a is screwed to the flat plate portion 42a of the fixing metal fitting 42, thereby completing the assembly of the pitch bender 40 according to the present embodiment.

In the pitch bender 40 assembled as described above, as shown in FIG. 9, due to the contact between the resistor-side contact surface 41c1 and the light guide-side contact surface 48b1, the raised portion 48d of the light guide member 48 is sandwiched between the shaft-shaped member 41c of the variable resistor 41 and the fitting recess 47f of the wheel member 47. In other words, the variable resistor 41 holds the light guide member 48 together with the wheel member 47. By holding the light guide member 48 between the variable resistor 41 and the wheel member 47 in this manner, the light guide member 48 is held between them, so that the light guide member 48 is prevented from being displaced or dropped.

Further, in the pitch bender 40, the light emitted from each of the LEDs 43a to 43c enters from the lower portion of the light guide member 48, is guided in the plate of the light guide member 48 in the radial directions, and is emitted from the upper part of light guide member 48. Here, in the pitch bender 40, the raised portion 48d protrudes leftward from the left plate surface of the light guide member 48, and the light guide-side contact surface 48b1 that contacts the resistor-side contact surface 41c1 of the variable resistor 41 is provided in the inner side of the raised portion 48d. That is, the contact portion between the light guide member 48 and the variable resistor 41 is provided at a position shifted to the left from the plate surface of the light guide member 48 so that the light guide-side contact surface 48b1 does not overlap each LED 43a to 43c in the radial directions of the light guide member 48. Therefore, there is no recess or protrusion due to the structure for coupling the light guide member 48 with the variable resistor 41 on the optical path L1 of the light guided in the radial directions within the plate of the light guide member 48, thereby preventing the coupling structure from affecting the light guidance of the light in the light guide member 48.

As described above, the pitch bender 40 according to the present embodiment includes a plurality of LEDs 43a to 43c that emit light, the rotatable variable resistor 41, and the generally disk-shaped, the rotatable operation wheel 44 that is attached to the variable resistor 41. The operation wheel 44 has the light guide member 48 that guides the incident light from each of the LEDs 43a to 43c, and the wheel member 47 that is arranged on the left plate surface side of the light guide member 48. The variable resistor 41 has the shaft-shaped member 41c that holds the light guide member 48 therebetween.

Since the pitch bender 40 is configured as described above, the light guide member 48 is held by the shaft-shaped member 41c of the variable resistor 41, and movements of the light guide member 48 in the axial directions of the shaft-shaped member 41c (horizontal directions) and in the directions parallel to its plate surface (vertical directions and front-rear directions) are prevented or suppressed. As a result, it is possible to prevent the light guide member 48 from being displaced or dropped due to repeated rotations of the operation wheel 44. For this reason, in the pitch bender 40, in a configuration in which the light emission status of each of the LEDs 43a to 43c is controlled according to the rotation angle of the shaft-shaped member 41c about its axis, the reliability of the light guide member 48 that guides the light according to the operation of the operation wheel 44 can be enhanced.

In the pitch bender 40, the variable resistor 41 has the resistor-side contact surface 41c1 that contacts the light guide member 48, and the light guide member 48 has the light guide-side contact surface 48b1 that contacts the resistor-side contact surface 41c1. As a result, a part of the variable resistor 41 can be brought into contact with a part of the light guide member 48, thereby providing a specific mechanism for sandwiching the light guide member 48 between the variable resistor 41 and the wheel member 47.

In the pitch bender 40, the shaft-shaped member 41c is rotatable around its axis; the resistor-side contact surface 41c1 is provided on the shaft-shaped member 41c; the light guide member 48 has the light guide-side through hole 48b through which the shaft-shaped member 41c is inserted; and the light guide-side contact surface 48b1 is provided in the opening of the light guide-side through hole 48b. This provides a specific configuration for bringing a portion of the shaft-shaped member 41c into contact with a portion of the light guide member 48 while the shaft-shaped member 41c is inserted into the light guide-side through hole 48b.

In the pitch bender 40, the light guide member 48 guides the incident light from each of the LEDs 43a to 43c in the radial directions, and the light guide-side contact surface 48b1 is provided at a potion not overlapping each of the LEDs 43a to 43c in the radial directions of the light guide member 48. As a result, there is no recess or protrusion due to the structure of the contact between the light guide member 48 and the variable resistor 41 on the optical path L1 of the light guided in the radial directions within the plate of the light guide member 48. Therefore, it is possible to prevent the structure of the contact between the light guide member 48 and the variable resistor 41 from affecting the light guidance of the light in the light guide member 48, and a high reliability of the light guide member 48 can be ensured while maintaining good visibility of light emitted from the light guide member 48.

Also, in the pitch bender 40, the resistor-side contact surface 41c1 and the light guide-side contact surface 48b1 are perpendicular to the axial direction of the shaft-shaped member 41c. As a result, the resistor-side contact surface 41c1 and the light guide-side contact surface 48b1 come into contact with each other along the axial direction of the shaft-shaped member 41c, so that the light guide member 48 can be sandwiched and held firmly along the axial direction of the shaped member 41c between the shaft-shaped member 41c and the wheel member 47. Therefore, it is possible to more effectively prevent the light guide member 48 from being dislocated or dropped.

Further, in the pitch bender 40, the wheel member 47 has the wheel-side through-hole 47b through which the shaft-shaped member 41c is inserted, and the shaft-shaped member 41c is press-fitted into the wheel-side through-hole 47b. As a result, the shaft-shaped member 41c is firmly fixed to the wheel member 47, and the wheel member 47 can be prevented from coming off the shaft-shaped member 41c. Therefore, the light guide member 48 can be reliably held between the shaft-shaped member 41c and the wheel member 47, and the occurrence of positional displacement and falling off of the light guide member 48 can be more effectively prevented.

Also, in the pitch bender 40, the light guide member 48 and the wheel member 47 are bonded together via the double-sided adhesive tape 49. As a result, the light guide member 48 can be supported by the wheel member 47, and the light guide member 48 can be firmly held between the shaft-shaped member 41c and the wheel member 47. Furthermore, by using the double-sided adhesive tape 49 that maintains its viscosity in a semi-solidified state even after bonding as compared with the case of using an adhesive that solidifies after bonding, a sudden separation or peeling off between the wheel member 47 and the light guide member 48 can be prevented. Therefore, the reliability of the light guide member 48 can be sufficiently ensured.

The electronic keyboard instrument 10 according to this embodiment also includes the pitch bender 40. As a result, when the player repeatedly rotates the operation wheel 44 while playing the electronic keyboard instrument 10, it is possible to prevent the light guide member 48 from being displaced or dropped. Therefore, the durability of the pitch bender 40 can be enhanced, and the reliability of the electronic keyboard instrument 10 can be enhanced.

It should be noted that the embodiments described above are presented as examples and are not intended to limit the scope of the invention. These novel embodiments can be implemented in various other forms, and various omissions, replacements, and modifications can be made without departing from the spirit of the invention. These embodiments and their modifications are included in the scope and gist of the invention, and are included in the scope of the invention described in the claims and its equivalents. For example, in the above embodiments, the pitch bender was exemplified as the manipulator, but other manipulators such as a modulation wheel may be used. Further, for example, in the above-described embodiments, an electronic keyboard instrument is used as an example of an electronic musical instrument, but other electronic musical instruments that do not have a keyboard may be used.

What is claimed is:

1. A manipulator, comprising:
a light source that emits light;
a rotatable member that is rotatable around an axis; and
an operation member having a substantially disk shape, attached to the rotatable member so as to be rotatable together with the rotatable member, the operation member including a light guide member that guides light incident from the light source, and a wheel member arranged on one plate surface side of the light guide member,
wherein the rotatable member has a holding portion that holds the light guide member.

2. The manipulator according to claim 1, wherein the holding portion of the rotatable member has a first contact surface that contacts the light guide member, and the light guide member has a second contact surface that contacts the first contact surface.

3. The manipulator according to claim 2,
wherein the holding portion is a shaft-shaped member rotatable around the axis, and the first contact surface is provided in the shaft-shaped member,
wherein the light guide member has a first through hole through which said shaft-shaped member is inserted, and
wherein the second contact surface is provided within an opening of the first though hole.

4. The manipulator according to claim 3,
wherein the light guide member guides the incident light in radial directions, and
wherein the second contact surface is arranged at a position that does not overlap the light source in the radial directions.

5. The manipulator according to claim 3, wherein the first contact surface and the second contact surface are orthogonal to an axial direction of the shaft-shaped member.

6. The manipulator according to claim 4, wherein the first contact surface and the second contact surface are orthogonal to an axial direction of the shaft-shaped member.

7. The manipulator according to claim 3, wherein the wheel member has a second through hole through which the shaft-shaped member is inserted, and the shaft-shaped member is inserted into the second through hole.

8. The manipulator according to claim 4, wherein the wheel member has a second through hole through which the shaft-shaped member is inserted, and the shaft-shaped member is inserted into the second through hole.

9. The manipulator according to claim 5, wherein the wheel member has a second through hole through which the shaft-shaped member is inserted, and the shaft-shaped member is inserted into the second through hole.

10. The manipulator according to claim 6, wherein the wheel member has a second through hole through which the shaft-shaped member is inserted, and the shaft-shaped member is inserted into the second through hole.

11. The manipulator according to claim 1, wherein the wheel member and the light guide member are affixed to each other by a double-sided adhesive tape.

12. An electronic musical instrument, comprising:
the manipulator as set forth in claim 1; and
an control board connected to the manipulator and causing electronically synthesized sound to be generated and output.

13. An electronic musical instrument, comprising:
the manipulator as set forth in claim 2; and
an control board connected to the manipulator and causing electronically synthesized sound to be generated and output.

14. An electronic musical instrument, comprising:
the manipulator as set forth in claim 3; and
an control board connected to the manipulator and causing electronically synthesized sound to be generated and output.

15. An electronic musical instrument, comprising:
the manipulator as set forth in claim 4; and
an control board connected to the manipulator and causing electronically synthesized sound to be generated and output.
